(19) United States
(12) Patent Application Publication
(10) Pub. No.: US 2015/0305314 A1
(43) Pub. Date: Oct. 29, 2015

(54) Compact Portable Fishing Pole

(71) Applicant: Tim Rohrer, Bend, OR (US)

(72) Inventor: Tim Rohrer, Bend, OR (US)

(21) Appl. No.: 14/694,754

(22) Filed: Apr. 23, 2015

Related U.S. Application Data
(60) Provisional application No. 61/983,369, filed on Apr. 23, 2014.

(51) Int. Cl. A01K 87/08; A01K 97/06; A01K 97/04; A01K 89/00; A01K 97/08

(52) U.S. Cl. CPC A01K 87/08; A01K 89/00; A01K 97/08; A01K 97/04; A01K 97/06

(57) ABSTRACT

A portable fishing device is provided having a handle with a spool providing a line reel rotationally engaged at one end which is sized for placement in a clothing pocket when not being employed. The handle has a gripping area adjacent one side of the spool and a lanyard having a loop positionable around the arm or wrist of a user gripping the handle in the gripping area to tether the fishing device to the user. The fishing device has only one moving part, that being the spool on the handle, to minimize potential loss of use from mechanical failure.

This application claims the benefit of U.S. Provisional Application No. 61/983,369 filed on Apr. 23, 2014, and is included herein in its entirety by this reference.

### BACKGROUND OF THE INVENTION

1. Field of the Invention

The present invention relates generally to fishing poles. More particularly, the disclosed device relates to a compact portable fishing pole with a line reel which is compact and can be transported easily for impromptu fishing.

2. Prior Art

Personal non-commercial fishing has always been a past time and means of sustainment. As such, the array of fishing equipment including rods, reels and other casting equipment have become widely available. Although advanced equipment has been developed to aid the fisherman in catching more and larger game, such fishing poles and reels are designed for planned fishing excursions by land or boat, are not designed to be portable on an every-day basis.

For those who work the fishing industry or proximate to fishing areas and wish to have the opportunity to fish without preplanning to pack a fishing pole and reel, or for those wishing to have a simple, non-jamming fishing device such as survivalists or hikers, there is no easy solution which can be depended upon in all situations. An example of compact fishing devices would be U.S. Pat. No. 3,447,254 to Sobel which teaches a collapsing fishing rod for ease of transportation, which includes mechanical reels and telescopic rod components and the like. However, for a hiker or survivalists or just a person wishing to have an easy to use and reliable fishing component, the complexity of the prior art mechanically, and the size of most prior art components, are burdensome.

Even where such devices include a reel and collapsing rod the size is larger than is generally desirable for carrying in a pant pocket or in the minimal space accessible to a hiker or back packer. Further, the prior art while attempting to provide high quality mechanical gear in a compact package, also provides complex interacting mechanical components which in long term use in the dusty and muddy environments of fishing, are prone to malfunctioning. For a hiker or survivalists who may depend on a compact fishing device for food and survival, a fishing device with complex interacting mechanical components is a malfunction waiting to happen. The inability to fish for food in some instances, such as in survival kits for survivalists or those who may be victims of a disaster, can easily result in the inability for a user to feed themselves when such is required.

As such, there is a continuing and unmet need for a compact and portable fishing pole device, which is especially compact so as to easily fit into a pocket or purse or for example survival kit or backpack. Such a device should be easy to use, and quick to deploy because fishing opportunities can come suddenly.

In addition to being especially compact, and employable quickly when the fishing opportunity presents itself, such a device must be configured without complex mechanical components which are prone to malfunction, especially in the wet and dirt-prone environment of fishing from land into water. Still further, if provided as a kit, such a device should include a small package size which contains both fishing device and sufficient line and lures to be easily and quickly configured to support a fishing session.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision of an especially compact and useful fishing pole and reel configured with minimal mechanical parts thereby minimizing any chance for disjunction. The disclosed device includes a handle adapted for gripping by the hand of a user on which a spool is operatively engaged to dispense and wind fishing line. The spool includes a contact surface adjacent the gripping area of the handle to allow the user to impart drag to unwinding of line from the spool should such be desirable.

The spool is rotationally engaged on one end of the handle and in a current mode this rotational positioning is held by a first retention nut on a first side of the spool and a second retention nut on the opposing side of the spool. On the opposite end of the handle from the spool is a lanyard or loop which is sized to surround the hand of the user while gripping the handle with the device in an as-used position during fishing. This lanyard is of a length which will fold over and position the loop in line with the gripping portion of the handle and is particularly preferred to prevent the handle and spool from becoming lost when the line is pulled upon by a fish should the user's grip slip.

The device is assembled by inserting the handle through the spool and then engaging the first and second retention nuts to the handle on either side of the spool to loosely constrain the spool from moving and translating along the handle. However, they are positioned loosely enough against the sides of the spool to allow a free rotation of the spool around the end of the handle. The retention nuts are fastened to the handle through any fastening means as would occur to those skilled in the art to accomplish this task, including but not limited to a frictional engagement therewith, glue, epoxy, threads, screws, bolts or other cooperative fasteners which will hold the spool in a rotational engagement with the handle.

The axisymmetric spool is similar to general and previous line or thread spool constructions where outer walls contain and align the fishing line for easy winding and unwinding. The spool should be deep enough to contain the length of fishing line which is generally necessary for fishing. One side edge of the spool is positioned adjacent the gripping portion of the handle where it may be contacted by the gripping hand to impart drag on the spool. The opposite side may be contacted by the free hand to impart drag also.

At the end of the handle opposite the spool, a lanyard is attached. The lanyard may be engaged by threading through the depicted endcap engaged to the handle, or by other means to affix it to the handle. The lanyard is of a length to position the loop thereof around the wrist of the user gripping the handle and thereby prevents the device from slipping out of the user's hands and being lost during fishing operation. If an end cap is employed to secure the lanyard to the handle either the endcap or the lanyard or both can be engaged by one or a plurality of engagements such as threads, screws, glue, epoxy, molding, over-molding, welding, or ultrasonic welding. The end cap might also be frictionally engaged.

For ease of use and transportability, alternate modes of the device can include further gripping features which can be formed with or attached to the handle. In a separate preferred mode, the handle can contain one or more loops or holes to help guide the fishing line. Additionally, a second preferred mode exists where the handle is collapsible for easy storage.

Increased usability can also be obtained through several alternative constructions of the spool, whereas indentations, pegs or slits can be used to allow the user to easily wind the fishing line. Bearings or slip surfaces embedded within the spool's center hole may also be used for smoother operation. Alternatively, pins or breaks can also be implemented to prevent the spool's rotation during winding or fishing. Finally the lanyard may additionally contain a drawstring, elastics or slip knots for increased securement to the user's arm.

The device is employed herein by winding a fishing line clockwise or counterclockwise around the spool and engaging a weight, bait, lure, or other fishing component at the distal end of the line. The user may simply unwind the line by hand to place it in the water or cast the line if the distal end is adapted for such. After casting or unwinding the line and fishing, where further fishing line may be released, the user can retrieve the hook, lure, weight, or other engaged gear, by winding the fishing line back onto the spool by hand or by hand-spinning the spool. The user can choose to store the fishing line and hook on or separate from the spool.

The lanyard may be composed of one or more flexible, durable, non-irritating materials in a list including but not limited to: string, rope, wire, thread, elastic bands, wires, etc. Additionally, all other parts of the device can be composed from one or more durable water resistant materials in a list including but not limited to: wood, plastic, fiberglass, metal, ceramics, or glass.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the invention to provide a fishing pole and reel which is small, mechanically simple, and which is portable for impromptu fishing

It is a further object of the invention to provide a fishing pole with a reel that can collect and unwind fishing line which rotates about a handle without any complicated mechanical components to minimize a chance for disjunction.

These and other objects, features, and advantages of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows an isometric exploded view of the device of FIGS. 2 and 4.

FIG. 2 depicts a perspective view of the device assembled and ready for line as in FIG. 4.

FIG. 3 is a side view cross section of the device of FIG. 1.

FIG. 4 depicts the device of FIG. 2 ready for gripping by a user in a gripping area of the handle adjacent the spool with line dispensed from the rotatably engaged spool.

FIG. 5 shows the device housed centrally in an optional container and held stable by surrounding secondary containers holding fishing components engageable to the line.

### DETAILED DESCRIPTION OF THE PREFERRED EMBODIMENTS OF THE INVENTION

In this description, any locational or directional prepositions such as up, upwardly, down, downwardly, front, back, top, upper, bottom, lower, left, right and other such terms refer to the device 10 as it is oriented and appears in the drawings and are used for convenience only. The use of such terms is not intended to be limiting in any fashion or to imply that the device has to be used or positioned in any particular orientation.

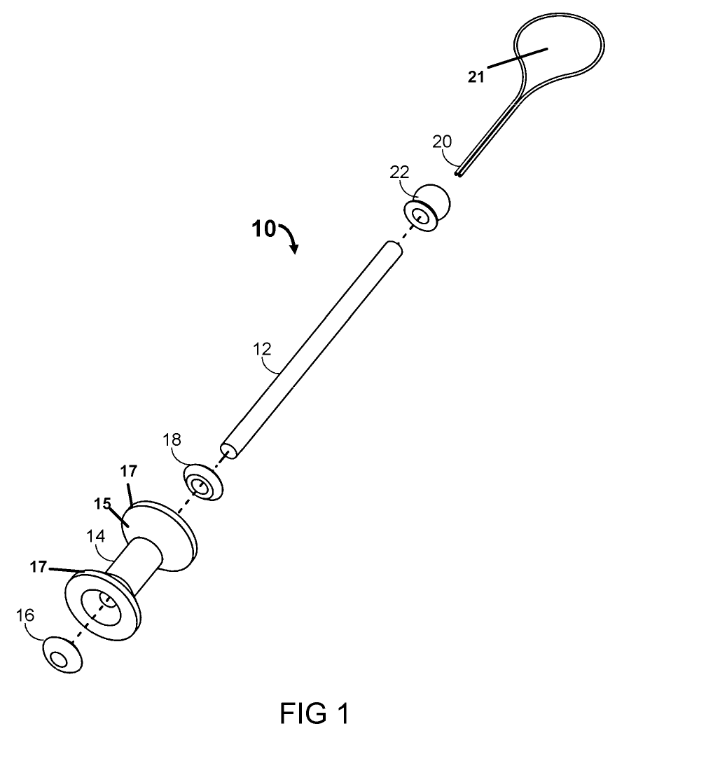

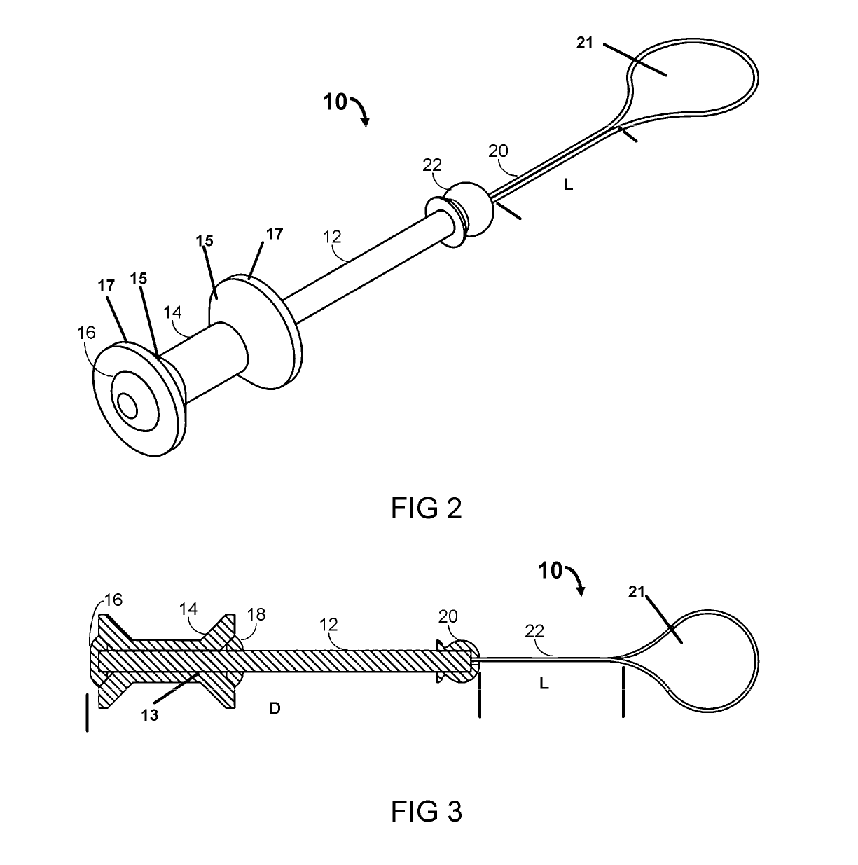

Referring to the drawings in FIGS. 1-5 wherein similar components of the device 10 are identified by like reference numerals, there is seen depictions of the device 10 which in FIG. 1 can be seen including a handle 12, spool 14, first retention nut 16, second retention nut 18, end cap 20 and a lanyard 22, which are configured and assembled to the device 10 shown in FIGS. 2-3 for example, to allow for a portable fishing device. The device 10 in the assembled form as shown in FIG. 3, preferably has a total length “D” from the first end engaged with a first retention nut 16 to a second end engaged with an end cap 22, of less than eight inches and more preferably in a pocket-stored version of the device 10 a total length “D” of six inches or less. The widest diameter of the assembled device 10 would be that of the diameter of the spool 14 which is preferably less than two inches. These preferred dimensions through experimentation have shown to fit best in pants and clothing pockets without causing the user discomfort when sitting or standing. The dimensions noted also work well for storing the device 10 in small compartments of backpacks and the like.

The device 10 is assembled by inserting a first end of the handle 12 through the spool 14 and engaging the first and second retention nuts 16 and 18 to the handle 12 on opposing sides of the spool 14. A means for engagement of the spool 14 to one end of the handle 12, positions the spool 14 loosely constrained from translating laterally on the handle 12, but having an axial passage 13 (FIG. 3) sized to allow for free rotation of the spool 12 about a first end of the handle 12 around the handle 12 circumference.

The first retention nut 16 and second retention nut 18 are engaged with the handle 12 through any fastening means adapted to the noted requirements as would occur to those skilled in the art. Such attachment can include one or a plurality of fasteners from a group including frictional engagement, glue, epoxy, threads, screws, bolts.

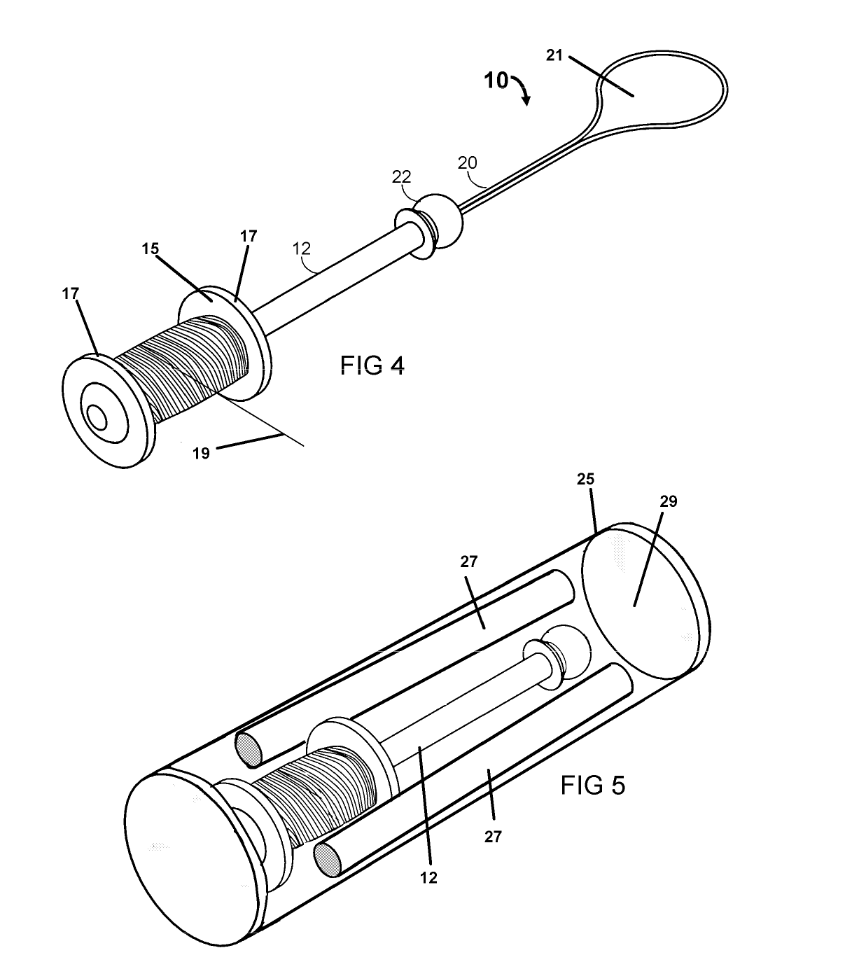

The axisymmetric spool 14 includes preferably a slightly curved inward or slanted surface 15 upon the opposing sidewalls 17. The slant or curve of the surface 15 forms a tapering of the width of the spool 14 from a wider portion at the circumference of the spool 14 to a narrower width between the sidewalls 17 adjacent the base of the spool 14 adjacent the pole 12. This taper or narrowing of the spool 14 where line 19 is wound and both contains and aligns the line 19 (FIG. 4) for easy winding and unwinding upon the spool 14. The spool 14 should be deep enough to contain a length of fishing line 19 which is generally necessary for fishing.

At the opposing end of the handle 12 of the device 10 opposite the spool 14, a lanyard 20 is engaged to the handle 12. This engagement is shown as being threaded through an endcap 22 which is then affixed to the second end of the handle 12. However, any means to operatively engage the lanyard 20 to the handle 12 will work well. The lanyard 20 has a first portion of sufficient length “L” between an engagement with the handle 12 and one side of the formed loop 21 to position a central area of the loop 21 when the lanyard 20 is folded toward the first end of the handle 12, to thereby position a loop 21 to surround the wrist of the hand of a user gripping the handle 12 in a gripping portion of the handle 12 adjacent the spool 14, and in-between the spool 14 and the endcap 22 at a second end of the handle 12, while in an as-used position for fishing.

Surrounding the wrist or arm or hand of the user gripping the handle 12 with the loop 21 of the lanyard 20 thereby prevents the device 10 from slipping out of the possession of the user should the handle 12 slip from the hands of a user during a fishing operation. The lanyard 20 being engaged to the wrist, arm, or hand of the user through engagement with the loop 21, will hold the device 10 proximate to the user until they can re-grasp the handle 12.

End cap 22 and lanyard 20 affixation to the handle 12 can be performed by one or more of the following fasteners from a group including threaded engagement, screws, glue, epoxy, molding, over-molding, welding, frictional engagement, or ultrasonic welding.

For ease of use and transportability, alternate modes of the device 10 can include further gripping features which can be formed with or attached to the handle 12. In a separate preferred mode, the handle can contain one or more loops or holes to help guide the fishing line 19. Additionally, in another preferred mode the handle 12 may be formed telescopically whereby it is collapsible for easy and more compact storage.

Increased usability can also be obtained through several alternative constructions of the spool 14, whereas indentations, pegs or slits can be used to allow the user to easily wind the fishing line. While not the most preferred mode with minimum mechanical components, bearings or slip surfaces positioned within the axial passage 13 (FIG. 3) of the spool 14 may also be used for smoother operation. Alternatively, pins or breaks can also be implemented to prevent the spool 14 rotation during winding or fishing. Finally the lanyard 22 may additionally include a drawstring, elastics or slip knots as a tightening means for increased securement to the arm of the user.

The device 10 is employed herein by gripping the handle 12 adjacent the spool 14 thereby positioning the device 10 to an as-used mode. During gripping the handle 12 the user will fold the lanyard 20 toward the spool 14 to position the loop 21 inline with the handle 12 and communicate their hand through the loop 21 as they grab the handle 12.

So gripped and constrained by the lanyard 20, line may be added to the spool 14 if not already present, by winding a fishing line 19 clockwise or counterclockwise around the spool 14. Positioning of the line 19 in water is accomplished by affixing a weight, lure, bait, hook, or other fishing component to the distal end of the line 19 and then unwinding the line as it sinks in the water or is cast from the spool 14 by the user.

After positioning the distal end of the line 19 and any attached fishing components in the water, further fishing line 19 may be released by unwinding the spool 14. Or, the user can retrieve the line 19 and pull the fishing components such as weights, leaders, bait, or hook from the water, by winding the fishing line back onto the spool 14 either by wrapping it with their hand while holding the handle 12 or by rotating the spool 14 while holding the handle 12. The user can choose to store the fishing line and any engaged leaders, weights, lures, hooks, or other fishing components on the line 19 while engaged with the spool 14 or separate from the spool 14.

The lanyard 20 may be composed of one or more flexible, durable, non-irritating materials adapted to encircle the arm or wrist or hand of the user and hold the device 10 engaged thereto. Such may include lanyard materials from a group including string, rope, wire, thread, elastic bands, wires, straps, or other flexible but comfortable materials.

Additionally, all other parts of the device can be composed from one or more durable water-resistant materials from a group including but not limited to: wood, plastic, fiberglass, carbon fiber, metal, ceramics, or glass.

The device as shown in FIG. 4 is essentially in an as-used configuration where the user can grip the handle 12 in a grip area adjacent to the spool 14. While gripping the handle the user may employ pressure from one of their fingers or thumb against the exterior surface of the sidewall 17 which allows the user to place drag force onto the and the unwinding of line 19 therefrom. FIG. 5 shows the device 10 housed in an optional container 25 which may also hold secondary containers 27 which hold bait, lures, weights, leaders, clips, and other fishing components engageable to the line 19. Particularly preferred is sizing the interior cavity 29 of the container 25 and the exterior size of the secondary containers 27 such that the device 10 is held stable and protected in a central axial position within the container 25 by a plurality of the secondary containers 27 which while shown as a plurality of two, will work better in a plurality of three or more to maintain the device 10 centered axially in the container 25.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A portable fishing apparatus, comprising:
a handle extending a length between a first end and a second end;
a spool, said spool having a first sidewall and having a second sidewall, said spool in a rotational engagement with said handle, at or adjacent to said first end of said handle;
said spool adapted for a wrapping of line thereon;
a lanyard having a first portion extending from an attachment with said second end of said handle to a loop portion;
said handle having a gripping portion adjacent an exterior surface of one of said first or second sidewalls of said spool, said gripping portion adapted for a user to grip said handle placing said fishing apparatus in an as-used position for fishing;
said exterior surface of said sidewall of said spool contactable by a digit of said hand of said user gripping said handle, to impart drag to rotation of said spool upon said handle; and
whereby said line is dispensable from said spool to position a distal end thereof into water for catching fish.

2. The portable fishing apparatus of claim 1 additionally comprising:
said first portion of said lanyard being of a length to position said loop to an inline position adjacent said gripping portion of said handle, wherein an arm, wrist, or hand, of a said user, gripping said handle with said fishing apparatus in said as-used position, is encircled by said loop.

3. The portable fishing apparatus of claim 1 wherein said rotational engagement of said spool with said handle comprises:
an axial passage sized for rotation upon a circumference of said handle;
a first nut adjacent a first sidewall of said spool; and
a second nut adjacent an opposite second side of said spool.

4. The portable fishing apparatus of claim 2 wherein said rotational engagement of said spool with said handle comprises:
an axial passage sized for rotation upon a circumference of said handle;
a first nut adjacent a first sidewall of said spool; and
a second nut adjacent an opposite second side of said spool.
a first nut adjacent a first sidewall of said spool; and
a second nut adjacent an opposite second side of said spool.

5. The portable fishing apparatus of claim 1 additionally comprising:
said spool having a declining width between said respective facing surfaces of said first sidewall and said second sidewall from a widest point of said width adjacent a circumferential edge of each of said first and second sidewalls, to a narrowest width at a position between said first and second sidewalls closest to said rotational engagement with said handle; and
said declining width defining a guide for winding and unwinding of said line upon said spool.

6. The portable fishing apparatus of claim 2 additionally comprising:
said spool having a declining width between said respective facing surfaces of said first sidewall and said second sidewall from a widest point of said width adjacent a circumferential edge of each of said first and second sidewalls, to a narrowest width at a position between said first and second sidewalls closest to said rotational engagement with said handle; and
said declining width defining a guide for winding and unwinding of said line upon said spool.

7. The portable fishing apparatus of claim 1 wherein said length of said handle is equal to or less than six inches.

8. The portable fishing apparatus of claim 2 wherein said length of said handle is equal to or less than six inches.

9. The portable fishing apparatus of claim 3 wherein said length of said handle is equal to or less than six inches.

10. The portable fishing apparatus of claim 4 wherein said length of said handle is equal to or less than six inches.

11. The portable fishing apparatus of claim 5 wherein said length of said handle is equal to or less than six inches.
